(19) United States
(12) Patent Application Publication
(10) Pub. No.: US 2009/0055087 A1
(43) Pub. Date: Feb. 26, 2009

(54) METHODS AND SYSTEMS FOR DISPLAYING AND AUTOMATIC DYNAMIC RE-DISPLAYING OF POINTS OF INTEREST WITH GRAPHIC IMAGE

(76) Inventor: Brandon Graham Beacher, Decatur, GA (US)

Correspondence Address: SEYFARTH SHAW LLP, 131 S. DEARBORN ST., SUITE 2400, CHICAGO, IL, 60603-5803, US

(21) Appl. No.: 12/187,955

(22) Filed: Aug. 7, 2008

Related U.S. Application Data
(60) Provisional application No. 60/963,806, filed on Aug. 7, 2007.

(51) Int. Cl. G01C 21/30

(52) U.S. Cl. 701/200

(57) ABSTRACT

Systems and methods for displaying maps and points such as points corresponding to points of interest on displayed maps are disclosed, the display of the points being dynamically and automatically altered in response to alterations in the displayed maps. The systems and methods include providing a map view and points therefor in response to a user request, as well as supplying preloaded map records for map views and points records so that the records and points are ready for display in the event the user selects actions to change the displayed view, such as by panning or zooming. For instance, the systems and methods may include AJAX techniques to download a library of points, as well as map records, a subset of which is initially displayed and a second subset is displayed in response to the user actions.

### CROSS-REFERENCE TO RELATED APPLICATION(S)

The present application claims the benefit of U.S. Provisional Patent Application No. 60/963,806, filed Aug. 7, 2007, and titled “Mapping System for Automatically Updating Points of Interest,” the entirety of which is incorporated herein by reference.

### FIELD OF THE INVENTION

The invention relates to providing points of interest to a graphical image, in particular, to a display of points of interest on a view of a geographical image in the form of a map and, more particularly, to an automatic and dynamic re-display of points of interest when the view of the graphical image is altered such as by panning or zooming.

### BACKGROUND

Heretofore, a number of well-known Internet or Web-based map applications existed. Generally speaking and by way of background, a number of entities such as Google, Yahoo!, MapQuest, and Microsoft provide computer applications allowing for an electronic interface with a graphical image representing geographical maps. While a traditional, paper or other hardcopy map presents a static view of a predetermined area, viewing of the electronic graphical image maps is adjustable or alterable so that one could “pan” or “zoom” the view presented. As is known in the field of art, the term “pan” refers to adjusting a graphical image rendered in 2 dimension in a plan manner to bring a new portion of the map, previously not shown, into a viewable area (such as a viewable area defined by a computer monitor or a software application interface or window), while at least a portion that was being shown is simultaneously moved out of the viewable area.

The term “zoom” encompasses both “zoom in” and “zoom out” and variations thereof. The former refers to a user focusing on a subset of a graphical image by enlarging that graphical image so that portions surrounding the subset are moved out of the viewable area. The latter term means to reducing the shown graphical image so that additional portions are added to the map that were previously out of the viewable area of the map. When a user zooms in, the detail of the selected area is enhanced such as by showing more streets or street names or other physical features, while the opposite is true for when zoom out is selected.

For obvious reasons, electronic maps are often generally displayed with an initial starting point and a default view. More specifically, a user typically retrieves a mapping software home page, such as http://maps.google.com for Google, which loads into the user's browser with a default view and a default zoom level. These defaults may be based on recognizing the user's computer (such as by IP address or a cookie) and determining the defaults based on previous searches or other known information, such as the location of the IP address. For instance, Google's application for Blackberry devices typically opens to the last view of the map the user selected, regardless of all other information, while other mapping applications often open with a default location based on a previously set “home” location. Still other map applications may open without a graphical image.

In any event, map applications generally either provide an initial search capability or allow a user to select a search capability with which a user can select a graphical image to be displayed based on a geographical location or area, which may be referred to as location herein for simplicity unless otherwise treated. Selection of a view by inputting a location (such as ‘123 Main Street, Anywhere, Any State’) or area (simply, ‘Anywhere, Any State’) results in the map application adjusting the viewable area to a default zoom level and to the selected view. The user is then able to select a zoom level that may then be used as the zoom level until the user again changes the zoom level, the zoom level determining the amount of detail shown and the amount of geographical area displayed as the viewable area. As noted above, the user may also pan the image to alter or adjust the geographical area that is within the viewable area.

Alternatively or in addition to selection of a view based on a location or area, a user may select points, or a category of points, of interest. For instance, in a particular view, a user may request that a category of points, such as businesses (such as “auto dealers” or “restaurants”) or cultural institutions (such as “museums”), be displayed. The map application will then annotate or populate that view with graphical flags indicating the location of the points.

In these prior art map applications, the display of these points is static. In response to a search query from the user, a set of points is gathered based upon the currently displayed view (i.e., the displayed location or area, selected either through a search query or by pan/zoom actions by the user). When the user subsequently adjusts or alters the view of the application (pan or zoom), the set of points is not revisited by the application. Accordingly, if a view of the Upper East Side of Manhattan, New York, were selected in conjunction with selecting a points of interest category of museums, a user panning ‘down’ to show Lower Manhattan would not automatically also receive new flags on the graphical image for the Maritime Museum or Battery Park Museum or the memorial museum on Ellis Island.

Prior art map applications typically make a necessary decision as to the number of points that can reasonably be displayed. For instance, a user selecting Seattle, Wash., with a zoom level showing the entire metropolitan area, who then selects a points of interest category of coffee shop, would likely be shown a graphical image map that was so littered with location flags as to be unusable. Therefore, the map application would make some type of decision as to what points should be displayed, based on the zoom level, referred to herein as a rank list.

However, prior art map applications are, again, static in the display of the points. When a user adjusts the zoom level, the map application does not re-search for the category of points. When the user adjusts the view by zooming in, the category points previously excluded are not re-captured for display. Therefore, if a user were to zoom in to focus on a particular neighborhood within Seattle, and no point of the rank list were present in the new viewable area, then no point of the category is presented.

Conversely, if a user viewing a relatively small geographical area and zooms out, the category of points is not re-searched. As an example, a user may view a portion of downtown St. Louis, Mo., and may secondarily search for a category of interest points of automobile rental. Upon discovering the paucity of available rental companies in the downtown area, the user would likely seek to find the closest rental companies to the displayed location. With prior art map applications, such requires an entirely new search, where the user selects a specified location or area, and selects a category, and the map application displays a new area with a predetermined number of point flags thereon. The user can then zoom to a desired portion of the displayed area.

However, continuing with this example, the user may consider crossing the Mississippi River and into East St. Louis, Illinois, as not being an option. Yet, the map application will present a view that is zoomed out from the St. Louis downtown area, and will likely show rental companies in and around the suburban-located Lambert Airport, as well as rental companies in East St. Louis. When the user pans and zooms to the Lambert Airport area, the display of points is again limited to that rank set selected by the map application, requiring the user to zoom and pan to the Lambert Airport area and then re-search the category.

Notably, were the user viewing the downtown area of St. Louis instead to attempt to pan in order to look for rental companies outside of the viewable area, the map applications would not re-search for the selected category. That is, after the user realizes no rental companies are present in the viewable area displayed on the computer, the user may suspect that moving the map to display a more westernly view, such as a view including downtown Clayton or Lambert Airport, would encompass rental companies. However, as the originally-searched view did not encompass Clayton, the newly displayed viewable area would not automatically populate with rental agencies, the map application instead requiring the user to re-search the category.

As another example, a user may desire to determine points of interest along a particular route. College students or recent graduates often take a summer driving trip across the country, particularly students whose experience with much of the United States is limited. In using prior art map applications with a point of interest category search function, a person planning such a trip is not able to simply pan along a particular route (i.e., a highway or road) and view what points of interest, including hotels or restaurants, may be along the route.

Additionally, the prior art map applications do not allow for autopopulation of perhaps out-of-the-ordinary points of interest. Tourist attractions such as the Corn Palace in Iowa, Silver Dollar City in Missouri, or Ruby Falls in Tennessee are not automatically shown to those who do not otherwise know of or search for such. Accordingly, a user panning along an intended driving route would not known that such sites existed unless the user repeatedly searched for various known categories, which themselves would not necessarily cause all points of interest to be displayed; for instance, even if a user were aware of the Corn Palace, it is difficult to even conceive of what search category would identify such or any related point of interest.

Accordingly, there has been a need for an improved map application.

### SUMMARY

In accordance with an aspect of the present invention, an application for displaying maps to users, the application including a server-hosted set of executable instructions, a webpage provided by the server-hosted executable instructions, upon a user request via a user terminal, to the user terminal, the webpage including a set of map records map, the map records being displayable in the webpage to the user on the user terminal and a set of points, the points corresponding to locations represented on the map records, wherein, a subset of the map records is displayable on the user terminal, a subset of the points is displayable on the user terminal and on the displayed map records, and alteration of the displayed subset of map records by user action results in a second subset of points to be displayed on the user terminal and on the displayed map records.

In some forms, the displayed map records are a map view displayed on the user terminal, and the user may alter a geographical area of the map view. The user may pan the geographical area to alter the map view and the points displayed thereon. The user may change a zoom level of the geographical area to alter the map view and the points displayed thereon.

In some forms, the webpage includes a webpage set of executable instructions provided by the server-hosted executable instructions for controlling the webpage and for communicating with the server-hosted executable instructions.

In some forms, the webpage includes preloading the set of map records and points, the user request being for only a subset of the map records and points. The webpage may utilize AJAX techniques to preload the map records and points, and to retrieve additional map records and points in response to user action, the retrieval occurring prior to user action requesting display of the additional map records and points.

In some forms, a first webpage is displayed on the user terminal in response to a request to the server, the first webpage having an initial map view including an initial geographic area and an initial zoom level, points displayed on the map view corresponding to the geographic area, alteration of the map view including alteration of the points displayed thereon, and the map records and points are preloaded to the computer terminal so that the initial map view displays less than the entirety of the preloaded map records and points, and at least as second map view is available by alteration by user action to display at least some points and map records that are preloaded and are not shown in the initial map view.

In accordance with a second aspect of the present invention, a method for displaying map views to a user is disclosed comprising the steps of providing a user interface on a computer terminal, loading a webpage to the computer terminal in response to a user request from a server, loading a set of map records to the computer terminal in response to the user request, loading a set of points to the computer terminal in response to the user request, displaying a map view on the webpage from the loaded map records, overlaying a set of points from the loaded points onto the displayed map, the set of points including at least one of the loaded points, receiving user action, and in response to the user action, altering the displayed map view and the points overlain on the displayed map.

In some forms, the step of receiving user action includes zooming-in on a portion of the displayed map view to enlarge the portion on the webpage as a subsequent map view and to exclude a peripheral portion from the subsequent map view, and wherein the points displayed on the subsequent map view are dynamically altered and selected from the loaded points to correspond to the subsequent map view.

In some forms, the step of receiving user action includes zooming-out from the displayed map view to include additional map records on the webpage as a subsequent map view, and wherein the points displayed on the subsequent map view are dynamically altered and selected from the loaded points to correspond to the subsequent map view.

In some forms, the step of receiving user action includes panning the map view to exclude a first portion of the displayed map view from the webpage and to add an additional portion to the map view to form a subsequent map view, and wherein the points displayed on the subsequent map view are dynamically altered and selected from the loaded points to correspond to the subsequent map view.

In some forms, the steps of displaying and overlaying include selecting a subset of the map records, and selecting a subset of points corresponding to the subset of the map records, and the step of altering the displayed map view and points includes selecting a second subset of the map records and selecting a second subset of points corresponding to the second subset of the map records.

In accordance with a further aspect of the invention, a method of displaying on a user terminal an automatically updating map including automatically updating points of interest thereon is disclosed, the method including the steps of providing a remote application on a host server, requesting a webpage from the remote application, displaying the webpage on the user terminal, inputting a geographic search request to the webpage, communicating the geographic search request to the remote application, receiving, at the user terminal, a set of map records and a set of points of interest corresponding the map records, displaying a map view including at least a portion of the map records on the user terminal, the map view corresponding to the geographic search request, and displaying less than the entirety of the set of points of interest on the user terminal and on the map view. In some forms, the step of displaying the map view includes displaying the entirety of the map records.

In some forms, the step of displaying the map view includes displaying less than the entirety of the map records.

In some forms, the method further includes step of receiving user instructions to alter the displayed map view, and including the step of altering the displayed map view in response thereto. The method may further include altering the displayed points of interest in response to the received user instructions to alter the display map view. The method may further include the step of preloading additional map records and points of interest in response to the received user instructions, the additional map records and points being stored for subsequent but not immediate display.

### BRIEF DESCRIPTION OF THE DRAWINGS

In the Figures, FIG. 1 is a representative view of a map view having flags thereon representing points of interest, and subsequent views corresponding to a zoom-in view and a pan view based on user actions;

FIG. 2 is a representational view of a system of the present invention showing a user terminal for operating a web-based form of a map application for displaying maps and dynamically updating indicated points of interest in the maps based on user actions such as pan and zoom;

FIG. 3 is a first representational view of the system of the present invention showing a form of the map application; and

FIG. 4 is a second representational view of the system of the present invention showing a second form of the map application.

### DETAILED DESCRIPTION

In a form of the present invention, a map application in the form of software or executable instructions stored on a programmable medium is disclosed for presenting and displaying a graphical image such as a graphical image representing a map of a geographical area. The map application includes a function for identifying and displaying points of interest relevant to a displayed graphical image, the displayed points of interest dynamically changing based on user actions changing or altering the map view displayed on the user's graphical user interface or computer monitor. The map view includes a default set of points of interest, generally an all-inclusive points of interest based on an overall ranking, the map application allowing the user to select a subset thereof. In a preferred form, the map application is an Internet or Web-based application, and the map view is displayed in a window of an Internet browser on a user's computer terminal.

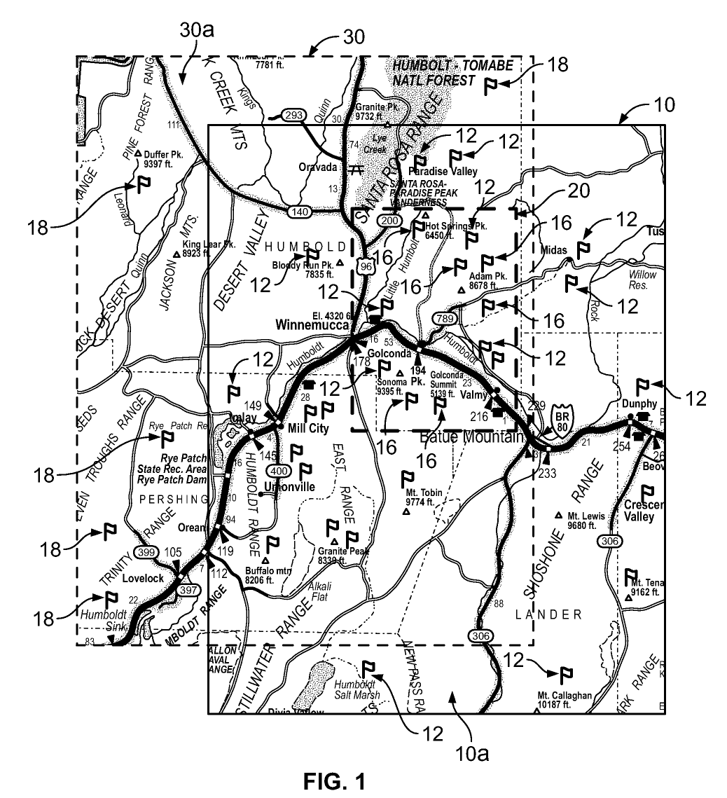

Referring initially to FIG. 1, a representative map view 10 is shown as being bounded by solid lines. The map view 10 represents a particular zoom level with a geographical location or area centered within the map view 10, and the solid lines indicate what is displayed on the user's browser 14 at that zoom level (FIG. 2). Within the map view 10, a plurality of flags 12 are shown representing the location of points of interest.

FIG. 1 also shows different map views resulting from user action. A zoom-in area 20 is shown bounded by dashed lines, the zoom-in area 20 representing an area of the previously displayed map view 10 that, when selected, would be enlarged in the browser window 44. In response to the user selecting the zoom-in action, the zoom-in area 20 of the map view 10 is enlarged and displayed on the browser 14 such that the portion of the map view 10 outside the zoom-in area 20 is no longer viewable on the browser 14. When enlarged and displayed, additional map detail is provided to the zoom-in area 20, such as additional streets or street names. Moreover, additional flags 16 are shown in dashed lines representing points of interest that were not shown when the previous map view 10 was displayed, but are added and shown when the zoom-in area 20 is selected and displayed. Preferably, a zoom slider is 13 is provided for selecting a zoom level (FIG. 2).

FIG. 1 also shows a pan area 30 bounded by dashed lines. In response to the user selecting the pan action in a particular direction, the map view 10 is shifted so that at least a portion 10a thereof (indicated as the area within the solid lines of map view 10 and outside the dashed lines of pan area 30) is no longer displayed on the user's browser 14 and so that at least a new map portion 30a (indicated as the area within the dashed lines of the pan area 30 and outside the solid lines of map view 10) is displayed on the user's browser 14. As can be seen, additional flags 18 are shown representing points of interest are shown in the pan area 30 yet, obviously, were not shown when the map view 10 was displayed. Preferably, a user may pan by clicking on the map view 10 with a mouse button and ‘dragging’ the graphical image in the desired direction.

Turning to FIG. 2, a map application 100 is disclosed that operates a database 102 including points-of-interest records 104 and including geographical records 106. As noted above, the map application 100 is preferably a web-based application and, as such, it should be recognized to include a local application 100a residing on and operating within the user's computer terminal 40 and a remote application 100b residing on and operating within one or more remote servers 110.

Upon a user request via a computer terminal 40 including a monitor 42, the computer terminal 40 running a browser 14 to show a window 44 displayed on the monitor 42, the map application 100 displays a view 50 in the form of a graphical image representing a geographical area in the browser window 44. The browser window 44 typically has a sub-window 44a that determines the display area provided on the monitor 42 for the view 50.

Upon an initial request, the map application 100 provides a query input 52 and may determine an initial default map view 50 displayed on the user terminal 40. The default map view 50, as discussed above, may be determined in any manner such as with a previous use of the map application 100 by the user or the computer terminal 40, with a pre-selected ‘home’ location, by determining a location of the computer terminal 40 (such as with an IP address), or by having a universal default view such as the entire United States of America. The query input 52 is a portion of the webpage allowing a user to input search criteria, such as a location and/or a category of points of interest.

In some forms, the map application 100 may refrain from presenting a map view 50 until after an input query or search request by the user. Whether the map application 100 provides an initial map view 50 based on a default view or based on input search criteria, the map application 100 determines an initial zoom level.

This initial zoom level may be based on a number of factors. In some forms, the map application 100 may consider the specificity of the user's geographical location or area request so that a high zoom level (i.e., zoom-in) is presented when a user requests a specific address, an intermediate zoom level may be provided when the user requests a larger location such as an airport or a park or a body of water, and a low zoom level may be provided when a city is requested. Even lower levels may be provided when a county, state, or country is selected.

The initial zoom level may also be determined by considering other factors, such as the numerosity of points of points of interest. For instance, a user may select a location or area, and may select a category of points of interest. The view 50 presented to the user in response may be provided with a zoom level intended to capture a meaningful number of such points of interest, represented as flags 12 in FIG. 1.

Therefore, in response to any search request by a user, a view 50 is presented on the browser 44 including flags 12 for points of interest. In the event the user makes no category selection for points of interest, the flags 12 shown are based on being within the geographical area of the view 50. If the user does select a category for the points of interest, the flags 12 shown in the view 50 are those that are within that category, as will be discussed in greater detail below.

As is common, the points of interest for a geographical area of the view 50 may be so great in number that presenting all such points would be unfriendly to the user, whether the user selected the category for the points of interest or not. Accordingly, a rank may be applied to the points of interest. The map application 100 may include a specific default maximum number of flags 12 that may be shown at once on a map view 50, or the map application 100 may consider the specific geographical area being shown in the view 50 and make a dynamic determination based on the same to determine a maximum number of flags 12 that are to be shown. In another form, the user selects or adjusts the maximum number of flags 12.

It should be understood that there are at least two factors that are relevant to the user's experience with regards to determining a subset of points of interest to be shown. The first is the ability of the view 50 to display flags 12 corresponding to a number of points of interest while remaining useful. For instance, requesting a map view 50 that shows hotel or rental accommodations in Myrtle Beach, S.C., would essentially show a solid streak of indistinguishable flags 12 that entirely obscures the underlying map itself, as the living spaces along what is known as The Strand is a virtual continuum of a large number of small locations. The second issue is a technical issue regarding the ability of the user's computer terminal 40 to handle the information.

The ranking applied may be determined in a variety of manners. For instance, the ranking may be determined by “popularity,” which itself may be determined by visitors to websites for the different points of interest, web-search requests for the points of interest, links to the websites, expert-assigned popularity scores such as a those visitor's bureau may assign, or any of a number of other manners. In some forms, the ranking may simply be derived by the map application 100 referencing a search engine such as Google or Yahoo!.

It is preferred that the webpage including the view 50 includes a statement indicating that a ranked subset is being shown, such as “100 museums of 234 museums being shown.” It is also preferred that the webpage including the view 50 indicates that all points are being shown, such as “92 museums of 92 museums being shown,” so that the user knows that the view 50 is sufficiently detailed to show all the points of interest for the shown geographical area of the view 50.

In the preferred form, the map application 100 displays the view 50 including flags 12 for points of interest. The flags 12 correspond to points of interest within the search query from the user, and the numerosity of those flags determined as described herein. Should the user not make a search query other than a location or area, the map application 100 essentially considers such as being “all points of interest” or, more narrowly, “all things to do” so that many things, such as dry cleaners, that are likely not of interest to the user are excluded. The view 50 displayed in response to the user's search is provided with a zoom level, as described above, and the flags 12 displayed therein are either for all the points of interest within the geographical area of the view 50, or a ranked subset as described above.

As the user alters or changes the view 50, as represented in FIG. 1 and discussed above, the displayed flags 12 may also alter. As the user zooms-in to the zoom area 20, the flags shown include the flags 12 that remain within the view 50; to the degree that all the points of interest were not already being shown by flags 12, additional flags 16 are added to the new view 50.

Conversely, as will be recognized, if the user zooms-out, the view 50 includes a larger geographical area, and the flags 12 shown may be adjusted in a variety of manners. In one manner, if the new view 50 supports such while remaining useful to a viewer and the user's computer terminal 40 can process the information, additional flags are automatically and dynamically added to the view 50. In another manner, the flags 12 displayed in the pre-zoom out view 50 may already be at the predetermined maximum, in which case the points of interest for the new view 50 are evaluated based on the ranking, and the flags 12 displayed in the new view 50 correspond to the highest ranked, it being likely that some of the pre-zoom flags are removed and new flags are added within the expanded geographical areas. Again, any changes in the displayed flags 12 are performed instantaneously, performed automatically without additional user search or query, and performed dynamically during movement or altering of the view 50.

Additionally, when the user pans the view, the flags 12 displayed in the 50 are dynamically and automatically altered. In one form, the flags displayed in the pan area 30 include the original flags remaining within the view 50, supplemented by flags 18 of the new geographical area portion 30a. In another form, the point of interest ranking may be consulted for any alteration of the view 50; in such a form, the flags displayed within the pan area 30 include those that are of the highest ranking, and conceivably all the points of interest in from the original view 50 may be removed should there be a sufficient number of points of interest of higher ranking be present within the portion 30a;

Each of the points of interest is assigned to a point of interest record 104, noted above. These POI records 104 include one or more tags 105 relating to the character or nature of the point of interest. For instance, the Vietnam War Memorial in Washington, D.C., may be tagged as a “thing to do,” a “tourist attraction,” a “memorial,” a “museum,” and a “historical war site.” The John Hancock Building in Chicago, Ill., may be tagged as a “thing to do,” a “tourist attraction,” a “restaurant,” a “parking garage,” “shopping,” etc.

These tags 105 correspond to keyword searches that may be performed by a user, as is known in the art. It should be noted, as will be discussed below, that the map application database 102 may build its own records and tags 104, 105, 106, or may use those provided by a publicly available search engine.

When a user performs a keyword search, the terms selected may not be the same as those provided in the database as tags 105. Therefore, the map application 100 may present to the user, such as via the query input 52, suggestive keywords. For instance, as a user begins to type a word into the query input 52, a suggested keyword drop down list may appear, the keywords arranged alphabetically. As a user types in “rest,” for instance, the list may automatically move to display both “restaurant” and “rest area,” as well as terms adjacent to these terms. Accordingly, if the user's intent had been to search for restaurants, they can quickly move to the full word with the mouse, thereby avoiding typing the rest of the word as well as risking a typographical error. If the user's intent was to search for “rest stop,” the user will recognize that such is not categorized, but that “rest area” is the appropriate term for the map application 100.

In a preferred form, the user may allocate the number of tags 105 relative to the search results in the form of displayed flags 12. In an exemplary use, the user may set a maximum number of flags 12, such as 100 flags, that may be shown at once on a map view 50. The user may ask for restaurants and museums, and the map application 100 searches these terms within the tags 105. The user may also select that no greater than 60 of the flags may be restaurants, allowing the balance of the flags 12 to be utilized in displaying museums. Accordingly, the top 60 restaurants will be shown, and up to 40 museums will be shown, each as points of interest represented by flags 12.

In some forms, information may be provided to the user for the specific flags 12 by providing information in hover windows. When the user moves the cursor or pointer to a flag 12 displayed on the browser 14, a window appears that gives information about the flag 12 or, more appropriately, the underlying point of interest for the flag 12. In one form, a list of points of interest is presented on the browser 14, and, when the corresponding flag 12 is hovered over by the pointer, the point of interest in the list is highlighted. In other forms, a hover window appears to the side of the pointer and displays relevant information to the point of interest, such as the name and address, and may include a phone number or hours of operation, as mere examples. In another form, the hover window may allow for certain commands, such as “hide” so that the flag 12 is removed (in the event the user clearly knows that this flag 12 is not of interest), “add to trip” so that a user can build a personalized map including the point of interest for the flag 12, or “details” which allows additional information to be provided or lead to a new window presenting additional information (such as a restaurant menu or a description of a historical site).

The map application 100 allows creation of personalized maps, as noted. In a preferred form, the map application 100 includes a login aspect so that the logged in user has an individualized account 130 in which the user's maps are saved and stored. This allows the user to continually build upon, and retrieve, their saved maps. To personalize maps, the user simply navigates the presented views 50, such as by panning and zooming, and saving tags 105 and the corresponding points of interest, and the user may provide start and end points, as well as intermediate points therebetween. In some forms, the map application 100 allows the user to make their personalized map available to a community of users in the same way that, for instance, Amazon.com allows users to build descriptive lists of books or music or the like and have those displayed to other Amazon users.

There are many different uses for the map application 100 that are advantageously advanced by the map application 100 and, specifically, by the automatic dynamic display of the flags 12 and the cataloging and display of flags 12 based on the view 50 presented. For instance, a user may desire to visit wineries in the state of Oregon, but have no idea where such are located. The map application 100 allows a user to select the geographical area of Oregon, and the tags 105 of “winery” in the query input 52. The entire state of Oregon is then displayed in the view 50, and up to the maximum number of flags 12 are shown indicating wineries. The user may zoom in to an area that shows a high concentration of wineries to determine a location(s) and plan a trip accordingly. Similarly, a user can make other broad searches, such as “top 10 golf courses in Kansas,” or “top 20 things to do in Georgia.”

In another form, the user may simply desire to drive north from San Francisco, Calif., and inputs “winery” as the search term. The user may then pan along a particular route, and the changing view 50 will automatically re-populate with new flags 12 indicating wineries along the route.

In a form, a user who may be searching for suburban shopping, and may start at a particular point on a map view 50, and then pan in a single direction, the map application 100 automatically causing the map view 50 to populate with shopping centers or retail stores. Similarly, the above-described user searching for rental companies in downtown St. Louis is able to pan westward, away from East St. Louis, while looking for a rental company.

Another convenient feature is the ability to exclude flags 12. For instance, a user in Washington, D.C., or Philadelphia, Pa., likely knows or can easily determine the most popular historical sites, which are considerable in number. The user may exclude flags 12 that are initially populated on a view so that the more obscure locations are added as allowed by the exclusion of other locations. For instance, the user who excludes the White House, The US Capital Building, the US Supreme Building, etc., may then be presented with Ford's Theater, the site of the Lincoln assassination, as such may not otherwise be ranked high enough to be presented initially. In another form, the user may pan the map so that an area of high concentration of well-known flags 12 are moved out of the view 50, such as the downtown area of Philadelphia, whereupon many less-popular points of interest are shown, such as historical buildings along Route 30 and Valley Forge, Pa.

In a further use of the map application 100, a user may have reservations for a specific restaurant, but know little else therearound for entertainment after dining. Because the map application 100 causes the map view 50 to autopopulate with “all things to do,” the user may simply enter the restaurant location, and the map view 50 will shown things proximately located thereto.

It should be noted that the map application 100 also supports the traditional “see more” feature, where the user presented with a first set of flags 12 may request a new set of lower rank to be displayed on the same map view 50. This selection may be remembered and adhered to as an exclusion should the view 50 be altered (i.e., pan or zoom), or may automatically return to the top ranking points of interest when the view 50 is altered, at the user's choice.

The user may also specify a time or date for their searches. For instance, a user may be looking for the closest public viewing location or locations for something, such as a movie. As a more clear example, a user may be searching for area bars or the like that are showing a pay-per-view broadcast of a boxing event, and such is only worthwhile to the user if such can be watched live. The map application 100 may allow the user to input a time or schedule aspect.

It should be noted that the underlying techniques of the map application 100 may be used for any type of categorizable information or locations, such as restaurants, tourist sites, government services, news events, services such as repair shops and dry cleaners, genealogical locations, etc.

A typical personal computer such as the computer terminal 40 is generally provided with sufficient memory that, if the only applications running were an operating system and the map application 100, many uses of the map application 100 would be supported in the manner described. That is, the map application 100 may be provided as a stand-alone program or application stored locally on and run from diskette or the computer's harddrive, and the memory of many computers would be sufficient to load and display a high number of points of interest as flags on the graphical image in an instantaneous or near-instantaneous manner. The map application 100 would operate well for limited geographical regions, but would eventually have to return to the stored information (e.g., harddrive) to retrieve new information once the user panned a significant distance from an initial location.

In a preferred form, as indicated above, the map application 100 is a web-based application having a remote application 100b hosted on a server 110 remote from the computer terminal 40, and a local application 100a running on the computer terminal 40 itself. The user requests a webpage from the server 110, and the server 110 returns the webpage including the local application 100a to the computer terminal 40, the webpage including a home screen having either or both of the default map view 50 and the query input 52.

The map application 100 utilizes so-called AJAX techniques so that the operation at the terminal 40 is smooth and instantaneous. AJAX techniques should be broadly viewed as techniques employing a variety of technologies that allow the terminal 40 to communicate with the server 110 and remote application 100b thereon in the background of the operation so that the user is generally not aware of when information is being passed between the terminal 40 and the server 110. Generally, but not necessarily, this exchange of information is asynchronous so that, essentially, the terminal 40 requests information in advance of it being needed and stores the information locally until it is needed. In various forms, AJAX includes one or more of the following: XHTML and CSS for presentations, Document Object Model for dynamic display of and interaction with data, XML and XSLT for the interchange and manipulation of data, XMLHttpRequest object for asynchronous communication, and JavaScripts. Additionally, other client-side scripting language may be used such as VBScript, IFrames can be used instead of XMLHttpRequest object for asynchronous communication, XML is not required (though it is preferred for the present map application 100), and JavaScript Object Notation or preformatted HTML or plain text may be used as alternative formats to XML.

In one form, a user request to the remote application 100b results in the remote application 100b sending a quasi-database of information in a library file 114, such as an XML file having a set point of interest records 104, for running within the local application 100a. In some forms, the remote application 100b may also send map records 106 to the local application 100a. Therefore, for a particular initial view 50, all the necessary information is provided to the computer terminal 40.

Additionally, the library file 114 includes information for what may be required should the user alter the view 50, such as by panning or zooming. The local application 100a on the computer terminal 40 and the remote application 100b continue to communicate as the user makes selections and selects actions, such as pan or zoom, so that the terminal 50 and remote application 100b communicate in the background to continually update the library file 114 with information that may be desired in subsequent operations by the user. As an example, if the user continually pans to views 50 in a specific direction, these actions are communicated to the remote application 100b, and the remote application 100b responds by providing additional map records 106 (for displaying additional geographic areas in that direction) and additional point of interest records 104 and tags 105 therefor so that the desired flags 12 are shown. This allows the operation of the map application 100, as far as the user viewing the computer terminal 40 is concerned, to appear seamless and fast. This also stands in contrast to prior art map systems that provide not automatic and dynamic population and re-population of displayed points of interest.

The map application 100, as discussed herein, is described as including the point of interest records 104 and the map records 106. However, it should be made clear that the map application 100 may utilize outside resources in a variety of manners. For instance, the map application 100 preferably utilizes geocodes and the US Federal Government's Geographic Names Information System for determining the proper map view 50 to display in response to a user search request. Additionally, the map application 100 may utilize a stand-alone map service, such as Google Maps or Mapquest, and overlay the points of interest records 104 and flags 12 therefor onto map records 106 retrieved from the map service.

In fact, as many map services have a total download or page view limit, it may be desirable to have the remote application 100b (located on a remote server 110) not directly communicate with a map service. In such a case, in response to a user request, the local application 100a communicates a request to a map service (thus providing the IP address of the computer terminal 40 to the map service) and a category request to the remote application 100b, which in turn need not communicate with the map service. Thus, the local application 100a retrieves, separately and simultaneously, the map records 106 from the map service and the point of interest records 104 and tags 105 from the remote application 100b.

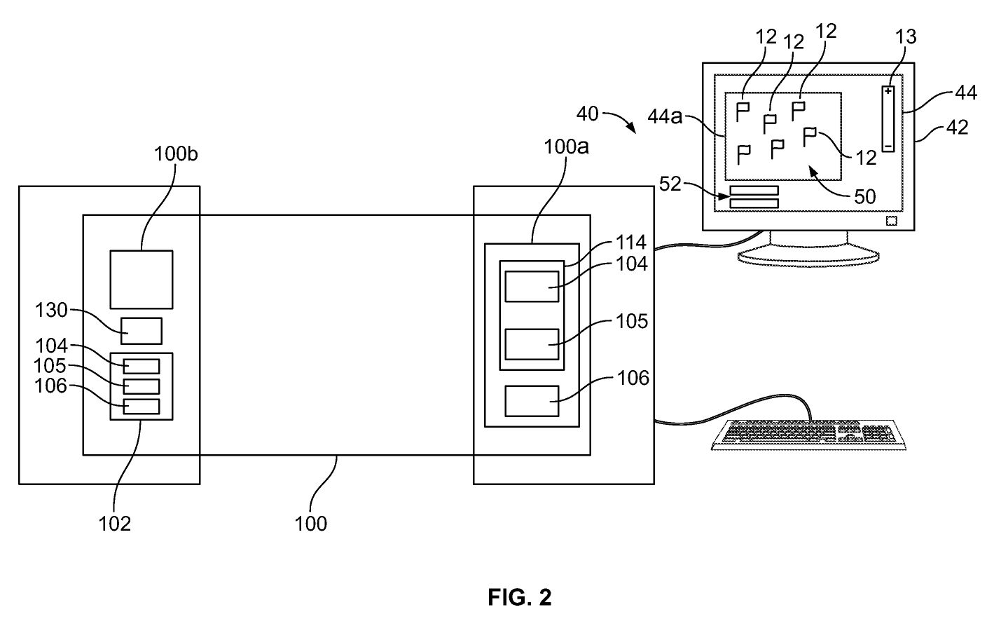

Turning to FIG. 3, a form of a system 160 for the map application 100 is shown. As can be seen, there is a set of computer executable instructions 162 stored on a memory 164, a second memory 166 for operating the instructions 162 loaded thereon, an input 168 for receiving requests from a user, a display 170 for displaying the image map view 50 including the flags 12 to the user, and a processing module 172 for processing the instructions 162 and the user requests.

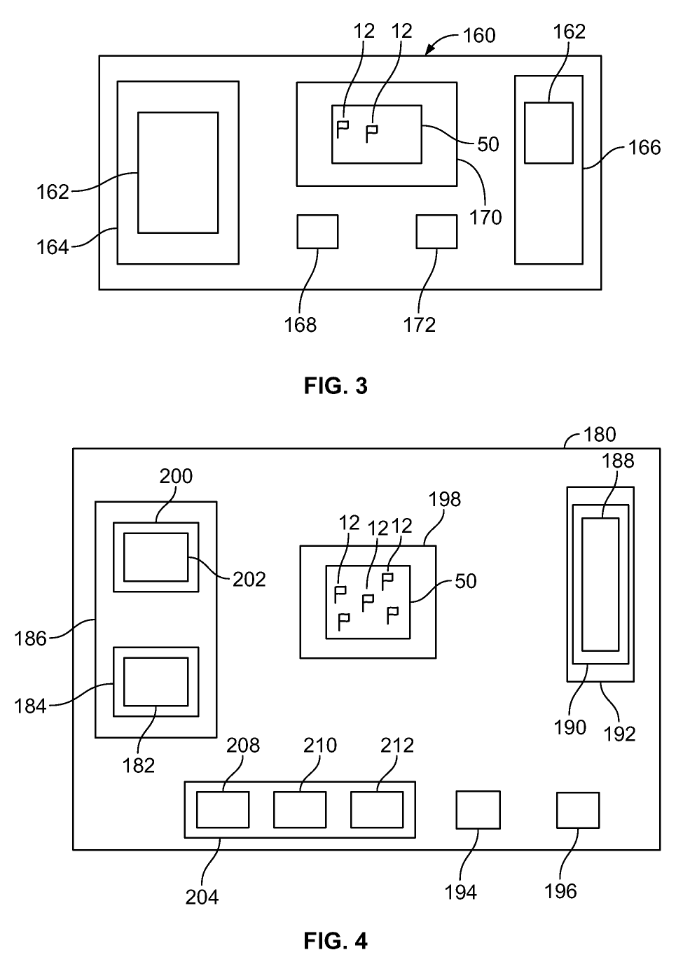

As a variation of the system 160, FIG. 4 shows a system 180 having a first set of computer executable instructions 182 stored on a memory 184 of a server 186, a set of instructions 188 loadable onto a memory 190 of a remote terminal 192, such as computer terminal 40, a processor 194 for running the loaded instructions 188 within the remote terminal 192, an input 196 for receiving requests from the user, and a display 198 for displaying the map image view 50 and the flags 12 to the user. Additionally, the server 186 may include a remote processor 200 for executing instructions 202 thereat, and the system 180 may include one or more additional services 204 (and communication connections) providing resource information. For instance, the additional services 204 may include a separate map service 208, such as Mapquest or Google, geographical look-up services 210, or ranking services 212, as described herein, and either or both of the remote terminal 192 or the server 186 may communicate with the additional services 204.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. An application for displaying maps to users, the application including:
a server-hosted set of executable instructions;
a webpage provided by the server-hosted executable instructions, upon a user request via a user terminal, to the user terminal, the webpage including:
a set of map records map, the map records being displayable in the webpage to the user on the user terminal;
a set of points, the points corresponding to locations represented on the map records; wherein,
a subset of the map records is displayable on the user terminal, a subset of the points is displayable on the user terminal and on the displayed map records, and alteration of the displayed subset of map records by user action results in a second subset of points to be displayed on the user terminal and on the displayed map records.

2. The application of claim 1 wherein the displayed map records are a map view displayed on the user terminal, and the user may alter a geographical area of the map view.

3. The application of claim 2 wherein the user pans the geographical area to alter the map view and the points displayed thereon.

4. The application of claim 2 wherein the user changes a zoom level of the geographical area to alter the map view and the points displayed thereon.

5. The application of claim 1 wherein the webpage includes a webpage set of executable instructions provided by the server-hosted executable instructions for controlling the webpage and for communicating with the server-hosted executable instructions.

6. The application of claim 1 wherein the webpage includes preloading the set of map records and points, the user request being for only a subset of the map records and points.

7. The application of claim 6 wherein the webpage utilizes AJAX techniques to preload the map records and points, and to retrieve additional map records and points in response to user action, the retrieval occurring prior to user action requesting display of the additional map records and points.

8. The application of claim 1 wherein a first webpage is displayed on the user terminal in response to a request to the server, the first webpage having an initial map view including an initial geographic area and an initial zoom level, points displayed on the map view corresponding to the geographic area, alteration of the map view including alteration of the points displayed thereon, and the map records and points are preloaded to the computer terminal so that the initial map view displays less than the entirety of the preloaded map records and points, and at least as second map view is available by alteration by user action to display at least some points and map records that are preloaded and are not shown in the initial map view.

9. A method for displaying map views to a user comprising the steps of:
providing a user interface on a computer terminal;
loading a webpage to the computer terminal in response to a user request from a server;
loading a set of map records to the computer terminal in response to the user request;
loading a set of points to the computer terminal in response to the user request;
displaying a map view on the webpage from the loaded map records;
overlaying a set of points from the loaded points onto the displayed map, the set of points including at least one of the loaded points;
receiving user action; and
in response to the user action, altering the displayed map view and the points overlain on the displayed map.

10. The method of claim 9 wherein the step of receiving user action includes zooming-in on a portion of the displayed map view to enlarge the portion on the webpage as a subsequent map view and to exclude a peripheral portion from the subsequent map view, and wherein the points displayed on the subsequent map view are dynamically altered and selected from the loaded points to correspond to the subsequent map view.

11. The method of claim 9 wherein the step of receiving user action, includes zooming-out from the displayed map view to include additional map records on the webpage as a subsequent map view, and wherein the points displayed on the subsequent map view are dynamically altered and selected from the loaded points to correspond to the subsequent map view.

12. The method of claim 9 wherein the step of receiving user action includes panning the map view to exclude a first portion of the displayed map view from the webpage and to add an additional portion to the map view to form a subsequent map view, and wherein the points displayed on the subsequent map view are dynamically altered and selected from the loaded points to correspond to the subsequent map view.

13. The method of claim 9 wherein the steps of displaying and overlaying include selecting a subset of the map records, and selecting a subset of points corresponding to the subset of the map records, and the step of altering the displayed map view and points includes selecting a second subset of the map records and selecting a second subset of points corresponding to the second subset of the map records.

14. A method of displaying on a user terminal an automatically updating map including automatically updating points of interest thereon, the method including the steps of:
providing a remote application on a host server;
requesting a webpage from the remote application;
displaying the webpage on the user terminal;
inputting a geographic search request to the webpage;
communicating the geographic search request to the remote application;
receiving, at the user terminal, a set of map records and a set of points of interest corresponding the map records;
displaying a map view including at least a portion of the map records on the user terminal, the map view corresponding to the geographic search request; and
displaying less than the entirety of the set of points of interest on the user terminal and on the map view.

15. The method of claim 14 wherein the step of displaying the map view includes displaying the entirety of the map records.

16. The method of claim 14 wherein the step of displaying the map view includes displaying less than the entirety of the map records.

17. The method of claim 14 further including the step of receiving user instructions to alter the displayed map view, and including the step of altering the displayed map view in response thereto.

18. The method of claim 17 further including altering the displayed points of interest in response to the received user instructions to alter the display map view.

19. The method of claim 18 further including the step of preloading additional map records and points of interest in response to the received user instructions, the additional map records and points being stored for subsequent but not immediate display.
